(19) United States
(12) Patent Application Publication
(10) Pub. No.: US 2007/0118804 A1
(43) Pub. Date: May 24, 2007

(54) Interaction model assessment, storage and distribution

(75) Inventors: Bohdan Raciborski, Redmond, WA (US); Egor Nikitin, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/280,168

(22) Filed: Nov. 16, 2005

(51) Int. Cl. G06F 17/00; G06F 9/00; G06F 3/00

(52) U.S. Cl. 715/745

(57) ABSTRACT

A system and method for gathering and sharing data corresponding to a user's level of interaction capability in using an electronic device gathers data actively by presenting forms requesting user input and passively by observing the user's behavior. The data gathered may be converted to a composite profile and/or kept as a set of sub-profiles, each of the set relating to different characteristics. An application programming interface may be provided to allow user interaction capability data to be provided by other applications, or even other devices, and also to make available the composite profile or set of sub-profiles to other applications or devices. The profile or set of sub-profiles may be used to adjust the user experience appropriate to the user's interaction capability.

### BACKGROUND

Electronic devices have become increasingly complex and are likely to become more complex over time. Microprocessor-based systems allow more features and options to be implemented in electronic devices ranging from cellular telephones to cameras to computers. In these feature-rich devices, the challenge of presenting a comprehensive, yet simple user interface can be daunting. New users can quickly become lost while trying to perform basic functions. Conversely, experienced users can be frustrated traversing layers of menus while accessing a frequently-used option or completing a lengthy wizard to complete configuration settings. Other attempts at coaching users often create more frustration, such as un-requested pop-up help.

User interfaces have attempted to address the issue of varying levels of interaction capability in a patchwork manner, from providing short-cut keys, to user-definable functions, to programming macros, to shipping different skill-level versions of the same product. However, changing the look and feel of a user interface to date has required the experienced user to learn about and activate the changes proactively. Moreover, there has been no ability for devices and applications to learn from each other about the user's capabilities and preferences, nor are there automatic, dynamically adaptable user interfaces.

### SUMMARY

An electronic device, such as a computer, personal digital assistant (PDA), cellular telephone, entertainment device, automatic teller machine (ATM), game console, etc., may collect information corresponding to user preferences, user interaction capability, and user accessibility requirements. The information may be collected directly requesting information about the user's proficiency, such as language skill level, and experience with electronic devices. The electronic device, or some managing process including an operating system, may also monitor user behavior to collect data regarding the user's proficiency in interacting with the computer. Data from external processes or other electronic devices may also be accepted and used in determining interaction capability. The data collected about the user's interaction capability may be used to catalog characteristics associated with the user which may be used on their own or may be used to develop a profile or a set of sub-profiles related to interaction capability. The characteristics and associated profile or profiles may be stored locally, on a server, or in the cloud, that is, on a network of affiliated computers. The profile may be used to tailor the user experience to match the interaction capability of the user. The profile may be used locally, made available via an application programming interface, or may be published, for example, on a peer-to-peer network. By using the application programming interface additional programs devices and services may obtain a profile and use them to adapt user interfaces, and data presentation in general, to best match the interaction capability of the user. The API may also be used for accepting interaction capability information from outside sources.

### BRIEF DESCRIPTION OF THE DRAWINGS

FIG. 1 is a simplified and representative block diagram of a computer network.;

FIG. 2 is a simplified and representative block diagram of a computer;

FIG. 3 is a flow chart depicting a method for developing and using an interaction capability profile;

FIG. 4 is a simplified and representative data format for a request for an interaction capability profile;

FIG. 5 is a simplified and representative data format for a response to the request shown in FIG. 4; and

FIG. 6 is a simplified and representative data format for providing interaction capability data.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

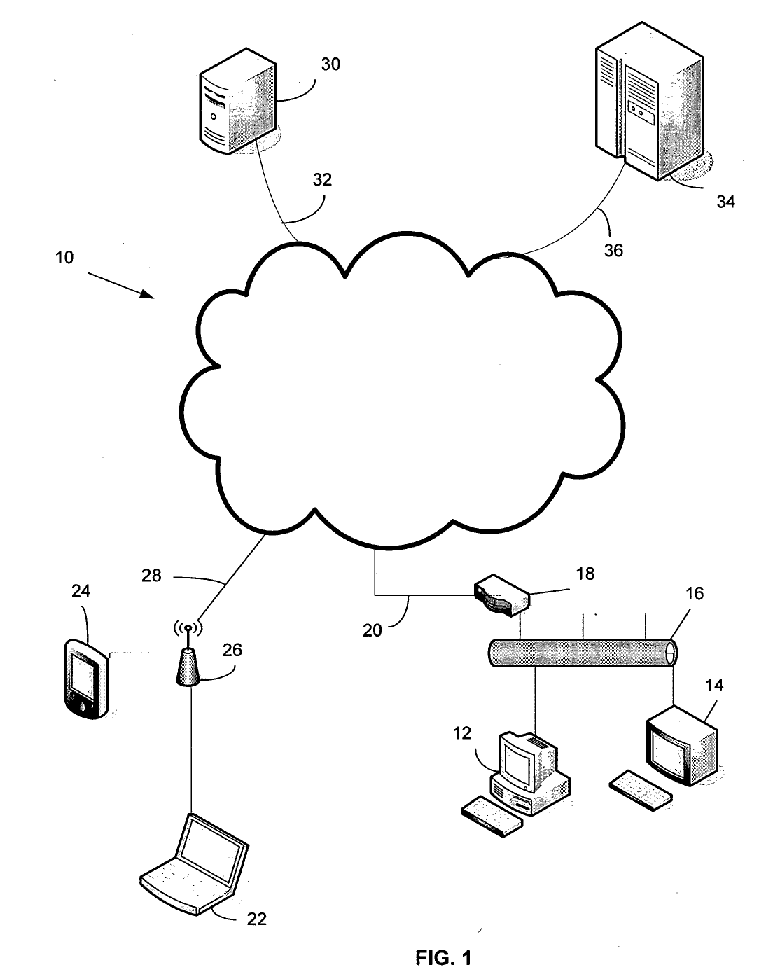

FIG. 1 illustrates a network 10 that may be used to implement a dynamic software provisioning system. The network 10 may be the Internet, a virtual private network (VPN), or any other network that allows one or more computers, communication devices, databases, etc., to be communicatively connected to each other. The network 10 may be connected to a computer 12, such as a personal computer and a computer terminal 14 via an Ethernet 16 and a router 18, and a landline 20. On the other hand, the network 10 may be wirelessly connected to a laptop computer 22 and a personal data assistant 24 via a wireless communication station 26 and a wireless link 28. Similarly, a server 30, such as a proxy server or edge server may be connected to the network 10 using a communication link 32 and a web server 34 may be connected to the network 10 using another communication link 36.

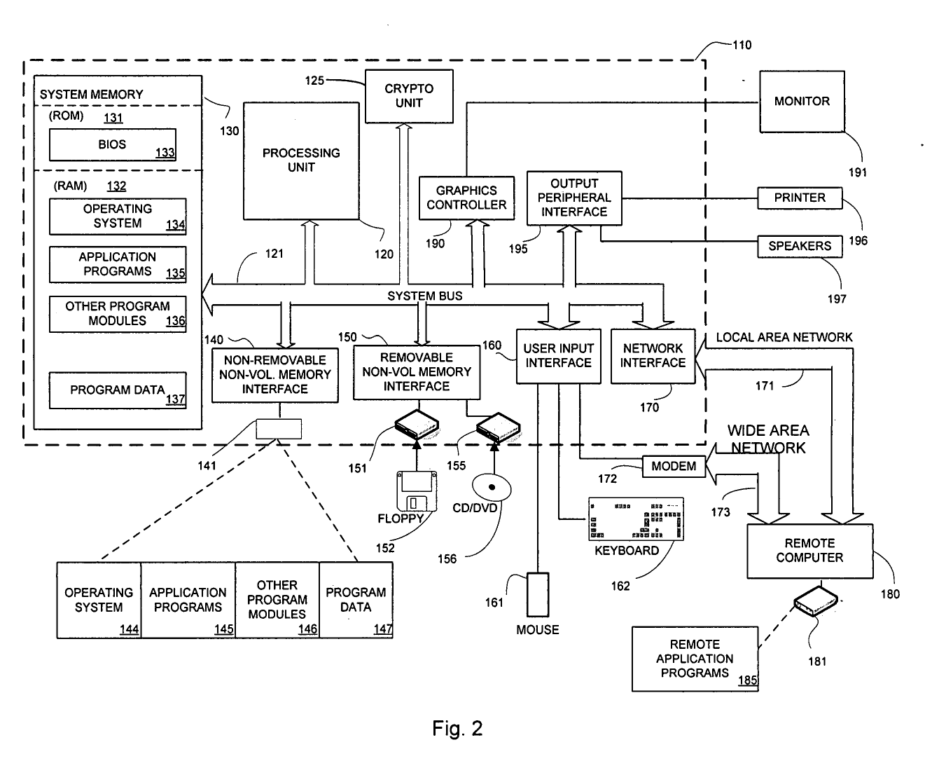

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. The cryptographic unit 125 may have a calculation function that may be used to verify digital signatures, calculate hashes, digitally sign hash values, and encrypt or decrypt data. The cryptographic unit 125 may also have a protected memory for storing keys and other secret data, such as an identification indicia, for example, an identifier representative of the computer or processing unit 120. Another function supported by the cryptographic unit 125 may be digital rights management, that in its simplest form is a variation of encryption. The cryptographic unit may also include a timer or clock (not depicted) to support expiration dates and some usage limits. The cryptographic unit may be physically located within the processing unit 120 or may be a separate component within the computer 110. In other embodiments, the functions of the cryptographic unit may be instantiated in software and run via the operating system.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks.(DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

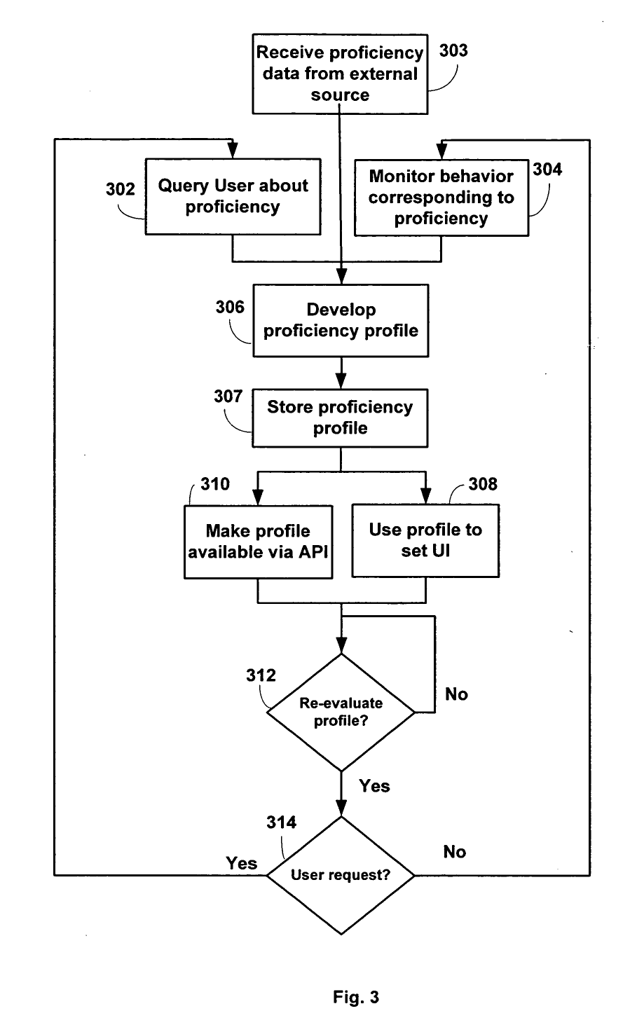

FIG. 3 is a flow chart depicting a method for developing and using an indicia or a profile indicative of a user's interaction capability in using an electronic device or related applications. The indicia may be used to capture both relatively fixed traits, such as disabilities, and traits that may change over time, such as typing ability. As discussed above, electronic devices, such as computers 110, continue to enjoy increasing levels of functionality and features. However, even as features and functions increase, the use of complex electronic devices is no longer the exclusive domain of sophisticated users. That is, the range of users has widened and now more than ever includes completely novice users. For example, the use of electronic devices, such as computer 110, is becoming more widespread in Third World countries. For those users, not only may using a computer be a new experience, but their language proficiency may be low, at least in the language of the user interface, for example, when the user is not working in his or her first language. However, as the user base increases, it also becomes more desirable to provide fewer, smarter versions of operating systems and applications, not more versions accommodating differing abilities.

To provide a personalized and improved user experience by providing a user interface commensurate with the user's interaction capability, data may be gathered about the user's interaction capability from a variety of sources and used to create a user interaction capability profile or sub-profiles. An interaction capability profile may be a fairly simple table or schema indicating user proficiency and capabilities and a user identifier. The interaction capability profile may include experience or proficiency in a number of individual areas such as typing and language, but may also include additional data such as device type, region, application, or usage scenario, such as business, game, etc. In this exemplary embodiment, three sources of interaction capability data may be used, direct query, monitored behavior, and data from external sources.

Direct query may be used to collect data about user's interaction capability. To collect data in this manner, questions with radio button selections or checkboxes may be presented to the user, using forms or other techniques, at block 302 for gathering a variety of data related to the user's experience, skill, and familiarity with the selected tasks or other attributes. In one exemplary embodiment, questions are posed by the operating system 134 during system set up or at the request of the user. For example, questions may be asked corresponding to accessibility needs, language skill level, education, tool usage, application usage, on-line activities, such as shopping or web-mail, and peripheral usage. Accessibility questions may include those related to special physical accommodations required for either use of input devices or the display of data, such as the use of large fonts for a visually impaired user. Language skill level questions may be targeted at the language of the primary user interface, for example, when a language interface in the user's native language is not available. For example, questions may be asked to help determine the user's reading level in the language of the user interface. Alternatively, spoken questions may be used for less literate users. Questions may also target education level. The use of education level may be helpful in targeting user interface elements but may also be used in predicting the rate at which the user may change his or her interaction capability level, and therefore, how often to re-check interaction capability. In one embodiment, the user may specify how often to update interaction capability.

User responses related to tool and application usage may be helpful in determining default values for settings with respect to the use of the tool or application. For example, a calculator may be set to scientific mode when the user indicates his or her primary interest is scientific calculations as opposed to balancing a checkbook. Similarly, answers related to applications and peripherals may be used to fine-tune the user interface, as an example, for tasks such as printing. For instance, a user who plugs in a memory stick from a camera for printing may be presented with a much simpler printing dialog than a user who downloads images directly from a camera for use with a sophisticated image editing tool.

Additional data regarding user interaction capability may be collected from external sources at block 303, such as data collected by application programs running on the electronic device, such as computer 110, or from data collected by external devices such as a cellular telephone (not depicted) or PDA 24. An additional source of interaction capability data may be from server-based applications that function similarly to locally-based applications but are hosted on a server such as server 34 and may make data available to authorized entities, even those functioning over a wide geographic area, for example, to service a frequent traveler.

In several cases it may be useful for the operating system 134, an application program 135, or other monitoring process to observe the user's interaction with the electronic device to help determine interaction capability. This may be useful for observing changes in user interaction capability over time without interrupting the user for periodic re-questioning. The observed changes may reflected in an on-going or continuous migration of the user interface characteristics at the local level (e.g. individual application), or more globally at the operating system level with data passed to other applications or services. Alternatively, the observed changes may be stored and user interface characteristics updated at an interval. Monitoring may also be useful in those cases where queries such as block 302 are difficult for the user because of language problems or because the user is so unfamiliar with computing that they are not able to initiate or manage the question/answer session discussed above. Monitoring or observing behavior 304 may include monitoring requests for help, both frequency and type, and may also include monitoring menu requests that result in no selection, or frequency of right clicks requesting options that all may indicate uncertainty or confusion. Advanced monitoring may include heuristics to analyze the type of help being requested or to develop patterns in menu requests.

An additional method of monitoring or observing behavior may be to assign experience points for activities performed by the user. For example, experience points may be subtracted for use of the undo function, use of menu screens for common activities, use of the escape key, etc. Experience points may be added when the user is observed performing device configuration, using hot keys, developing or using macros, creating dynamic links, etc. The calculation of experience points may be fine-grained, for example, evaluating keystroke-level activity or may be coarse, for example, monitoring operating system-level interactions with the computer. As experience points increase beyond certain threshold levels, the user may be asked to consider the use of an advanced user interface or offered an opportunity to upgrade to a higher-level product. The user may be offered an overview of the features and functions available and may be allowed to select which features and functions they would like added to the user interface, as well as primitive or seldom-used features and functions targeted at less experienced users that they may prefer to have removed.

The data gathered at blocks 302, 303, and 304, including experience points, may be used at block 306 to develop an overall indication of the user's interaction capability in using an electronic device, peripheral, application or service. In one embodiment, profiles or experience points related to different aspects of computer operation, such as accessibility requirements, language skill level, typing ability, etc., may be tracked separately and used to develop the overall profile. Some of the sub-profiles, such as those related to accessibility requirements, such as visual impairment, color blindness, hearing loss, or manual dexterity may be relatively fixed over time. Others, such as typing ability, may change fairly rapidly as the user becomes more experienced.

The profile may be calculated from the sub-profiles and experience points by simply summing the available numbers or a weighted average may be used to provide a more sophisticated profile. In some instances, the profile may be sufficient to indicate interaction capability but in other instances the individual sub-profiles may be stored in a schema and used to provide finer tuning for the user interface and overall user experience.

At block 307, the profile may be stored for later use, or used immediately without being stored. When stored, the profile may be stored locally, under the control of the operating system 134 or an application program 135. The profile may be stored on a network, such as a server, for example, with backup data or with other system configuration and setting information. Alternatively, the profile may be stored in a cloud, that is, a federation of devices providing storage to a corporation or other entity. A network, for example, Microsoft Network (MSN), may provide service to individuals. In any case, one goal of storage beyond the local computer 110 is to make the settings available to other entities that interact with the user and which may provide a benefit by tailoring the user interface.

The profile may be used at block 308 by the entity collecting the data and calculating the profile, in this example the operating system 134, for its own use setting parameters related to the user experience in order to better meet the needs and abilities of the user. Parameter settings adjustable according to the profile may include font size, menu presentation, tool tips, button caption text and activation, browser settings, security settings, privacy policy settings, language selection, default application settings, or presentation themes. Other, more complex adjustments may also be affected, such as, jargon level, language level, mouse behavior, presentation window attributes. Jargon are technology-specific terms, such as “megabytes” or “TCP/IP” (a network protocol) that may be useful to an experienced user, but would likely be frustrating to a novice. Language level may indicate vocabulary or sentence construction to be used in presenting information, such as help files. Language level may be expressed in terms of grade level, e.g. primary school/college or 4^{th} grade/12^{th} grade. Mouse behavior may be adjusted from constant-slow to variable with acceleration depending on whether the user is a novice doing word processing or a gaming expert. Presentation window attributes may include such items as window border thickness and scroll bar behavior.

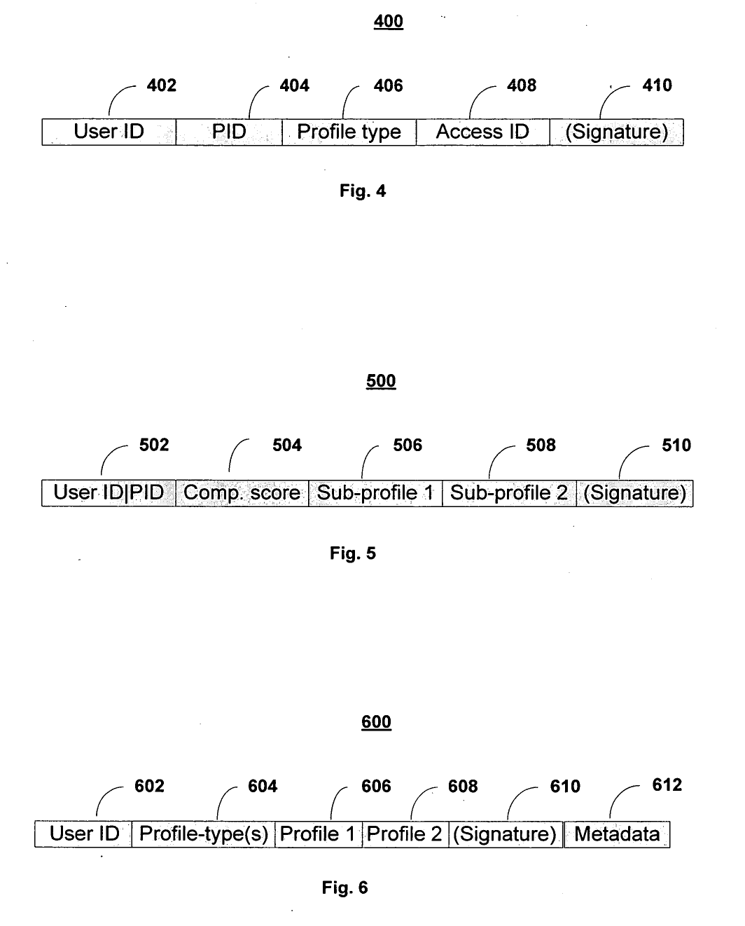

The profile may also be made available at block 310 via an application programming interface (API) for use by other application programs, other devices, or external data sources such as web sites to adjust their user interface characteristics. Either or both of the profile and the sub-profiles may be made available via the API. How frequently the OS, applications or other services update the user interface characteristics may vary from quite slow, e.g. monthly, to virtually continuously. The timing may be based on user settings or each application, OS or OS component may use its own schedule. More details on an exemplary API are discussed with respect to FIGS. 4-6 below. Briefly, a request may be made for the profile and/or the sub-profiles using the API. The profile may be shared via a reply API message responsive to the request or may trigger activities to get user interaction capability data, which may involve a deferred response. In an alternative embodiment, the profile may be published for use by related applications and devices. In either case, the profile or sub-profiles may be used to set parameters for configuration of the user interface for the requesting application or device, similar to the settings made at block 308.

Just as the profile may be used both locally and by remote devices or applications, the profile may be used by outside sources to tailor information for presentation to a user. For example, a web site may be given the profile either proactively during a Web session or responsive to a request from the web site. The profile may be stored as a cookie for later use by the web site. Alternatively, the web site may look for published profile data from a service provider such as an Internet Service Provider. The web site may then use the profile to tailor presentation of data corresponding accessibility requirements, language skill level, caption text, preferences, etc.

However, the profile may have personal information or data which the user may not wish to share. Then, the user may want to limit access to the profile or the individual sub-profiles. Accordingly, access rights may be set that require requests for the profile and/or sub-profile to present credentials meeting certain criterion before the profiles are shared. Credentials may be a simple password or more complex cryptographic method indicating the user has agreed to share the profile with the requesting party. When the use of the profile will be restricted to a local machine, for example by the operating system 134, presentation of credentials may not be required. In one embodiment, for each setting, the user can assign his or her own privacy level and choose the privacy level assigned to each website that is requesting information, allowing sharing of only equal or lower privacy setting data. Alternatively, users can use normal text-based description from a dropdown to identify which parties can access each of the entries. In yet another embodiment, users can check a set of checkboxes for each entry or a section of entries having personal information and identify whether signed or unsigned, local apps, web sites, or web services can obtain access to this entry.

FIG. 4 shows a representative data call 400 that may be used to request an interaction capability profile using an application programming interface. The data call 400 may include a user identifier 402 or other indicator regarding the target user. The user identifier 402 may be specific, such as a screen name or login identifier that can be tied to a particular user, such as an ATM card account number, game console user tag, or telephone number, depending on the particular device. The identifier may be a more anonymous identifier just used to match the user from one session to the next, for example, a cookie. Some form of process identifier (PID) 404 may be used in response for matching the original data call 400 to the eventual response. A profile type 406 may be used to indicate whether the composite profile and/or one or more individual sub-profiles are to be returned. As discussed above, some form of access control may be in place to protect the user's personal information. An access identifier 408 may be used for matching against access criteria. In some more secure environments, or when the request is made over a network, such as network 10 of FIG. 1, a digital signature 410 may be used to verify the source and accuracy of the data call 400.

FIG. 5 shows a representative data response 500 that may be used in response to the request data call 400. The user ID and/or the process ID 502 may be returned to the requesting entity. The user ID and/or process ID 502 may correspond to the user ID 402 and process ID 404 of FIG. 4. The profile 504 and one or more sub-profiles 506 508 may be included in the response, according to parameters in the request. As above, the data response 500 may be signed and include digital signature 510.

In addition to supporting requests for the profile over the API, the API may support receiving interaction capability data for use in updating the profile. Local caches of interaction capability data may be kept for use when on-line data is not available. FIG. 6 illustrates a representative data call 600 that may be used to supply interaction capability data to the managing process that calculates and stores the profile. The user identifier 602 again may be used to identify the user in question. In an alternative embodiment, user identifier 602 may not be used and instead a device identifier may be used to indicate the source of the information. The managing process may then need to use the device identifier to match with a local user. This may be as simple as requesting user information with a dialog box. One or more profiles, proficiency ratings, or experience points 606 608 may be included. As above a digital signature may also be included 610. Metadata 612 corresponding to test conditions or the profiles 606 608 may also be included.

In operation, a calling process may issue a data call 400 requesting a user interaction capability profile that may include one or more of the user identifier 402, process identifier 404, the profile type 406, and an access identifier 408. The data in the data call 400 may include a digital signature 410. A managing process, such as the operating system 134, may receive the data call 400. Whether to respond and with what data to respond may be determined by access control information 408 presented in the call or previously stored and available to the managing process. The managing process may then issue a data response 500 including either the requested data or the data authorized. The data response 500 may include identification data 502 and one or more profiles 504, 506, 508. The data response 500 may also include a digital signature 510.

Outside of this request response support, the API may support receiving data from outside systems. Such outside systems may include application programs running under the same operating system 134 applications running on a separate operating system (not depicted), or external devices such as a personal digital assistant 24, a laptop computer 22, or a cellular telephone. The data call 600 used to supply interaction capability data may include, as discussed above, the user identifier 602 or device identifier, and one or more profiles or other indications of interaction capability in a particular area. A signature may be included for verification of source and accuracy.

The use of an application programming interface and a related managing process for collecting user interaction capability data, developing a profile and sharing the profile with other applications offers users a new opportunity for having electronic devices meet them at their own level and grow with them as they progress. Similarly, developers and suppliers will benefit from increased user satisfaction and fewer customer service and training calls when using the techniques disclosed herein.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method for gathering and sharing data corresponding to a user's level of interaction capability for use in customizing a user experience with an electronic device comprising:
accumulating data about a user's level of interaction capability of operating an electronic device;
developing a profile corresponding to the user's level of interaction capability; and
using the profile to set at least one parameter corresponding to usability of the electronic device.

2. The method of claim 1, further comprising:
receiving a request for the profile; and
sharing the profile responsive to the request.

3. The method of claim 2, wherein sharing the profile comprises:
determining access rights corresponding to the request for the profile; and
sharing the profile when the access rights meet a criterion.

4. The method of claim 1, wherein developing the profile comprises monitoring activities indicating the user's interaction capability and preparing an updated profile as the user's interaction capability changes.

5. The method of claim 1, wherein accumulating data comprises collecting answers from a query presented by one of an operating system and application.

6. The method of claim 1, wherein accumulating data comprises observing user behavior by one of an operating system and application.

7. The method of claim 1, wherein accumulating data comprises accepting data from a source outside an operating system.

8. The method of claim 7, wherein accepting data from a source outside the operating system comprises accepting data from one of another electronic device, a networked data repository, and an application program.

9. The method of claim 1, wherein accumulating data comprises accumulating data corresponding to at least one of an identifier, accessibility requirements, language level, education, tool usage, application usage and peripheral usage.

10. The method of claim 1, further comprising making the profile available on a network-accessible resource.

11. The method of claim 1, wherein the at least one parameter is one of a font size, a menu presentation, a tool tip, a button caption, a browser setting, a security setting, privacy policy, a language selection, a default application setting, jargon level, language level, mouse behavior, presentation window attributes, and a presentation theme.

12. The method of claim 1, wherein developing the profile comprises developing a set of sub-profiles, each of the set of sub-profiles corresponding to a separate element of the user's level of interaction capability and developing the profile from the set of sub-profiles.

13. The method of claim 1, wherein developing the profile comprises developing a set of sub-profiles, each of the set of sub-profiles corresponding to a separate element of the user's level of interaction capability and sharing the set responsive to a request for the set of sub-profiles.

14. The method of claim 1, further comprising:
accumulating additional data corresponding to the user's level of interaction capability; and
developing an updated profile corresponding to a change in the user's level of interaction capability.

15. A computer-readable medium having computer-executable instructions for executing a method comprising:
accumulating data about a user's level of interaction capability of operating a first electronic device;
developing a profile corresponding to the user's level of interaction capability;
receiving a request for the profile from a requesting entity;
sharing the profile responsive to the request; and
using the profile to set at least one parameter corresponding to usability of an electronic device associated with the requesting entity.

16. The computer-readable medium of claim 15, wherein receiving the request further comprises receiving the request including access rights data, wherein sharing the profile responsive to the request is contingent on the access rights data meeting a criterion.

17. The computer-readable medium of claim 15, further comprising:
posting the profile to a server for use in configuring a user interface for a user device with access to the profile.

18. The computer-readable medium of claim 15, wherein accumulating data about a user's level of interaction capability comprises accumulating data observed about the user's interaction with the electronic device including one of requests for help and menu requests without selections.

19. A method of communicating between an operating system process and an other process comprising:
issuing, by the other process, a call requesting a user interaction capability profile having a plurality of call parameters including at least one of a user identifier, a process identifier, a profile type, and an access identifier;
receiving at a managing process the call requesting the user interaction capability profile and parsing the call to retrieve the plurality of call parameters; and
issuing, by the managing process a call response having a plurality of call parameters including at least one of a user identifier, a composite user interaction capability profile and a set of user interaction capability sub-profiles.

20. The method of claim 19, further comprising:
receiving by the managing process a call supplying data corresponding to an interaction capability of a user.
